(19) United States
(12) Patent Application Publication
(10) Pub. No.: US 2011/0095008 A1
(43) Pub. Date: Apr. 28, 2011

(54) MATERIALS MONITORING APPARATUS AND METHODS

(76) Inventor: Charles W. Birt, JR., Florence, SC (US)

(21) Appl. No.: 12/604,028

(22) Filed: Oct. 22, 2009

(51) Int. Cl. B23K 9/10

(52) U.S. Cl. 219/130.01; 219/130.1

(57) ABSTRACT

A monitoring apparatus is configured for association with a welding machine. The welding machine is configured to receive welding wire from a wire source. The monitoring apparatus includes a power input port, an indicator, and a detector, each of which is supported by a housing. The detector is in electrical communication with each of the power input port and the indicator. At least one of the housing and the detector at least partially defines a zone configured to removably receive a longitudinal portion of a welding wire passing from the wire source to the welding machine. The detector is configured to facilitate passage of electrical current from the power input port to the indicator depending upon whether iron material is disposed within the zone. Methods are also provided.

### TECHNICAL FIELD

The present invention relates to monitoring apparatus and methods. More particularly, the present invention relates to apparatus and methods for monitoring welding wire.

### BACKGROUND

A conventional welding machine is configured to receive welding wire for use during a welding process. A wire source, such as a spool or box, can be configured to dispense the welding wire to the welding machine. The welding wire is available in a variety of differing compositions, and can be selected by an operator to correspond with the type(s) of material to be welded by the welding machine.

### SUMMARY

In accordance with one embodiment, a monitoring apparatus is configured for association with a welding machine. The welding machine is configured to receive welding wire from a wire source. The monitoring apparatus comprises a housing, a power input port, an indicator, and a detector. Each of the power input port, the indicator, and the detector is supported by the housing. The detector is in electrical communication with each of the power input port and the indicator. At least one of the housing and the detector at least partially defines a zone configured to removably receive a longitudinal portion of a welding wire passing from a wire source to a welding machine. The detector is configured to facilitate passage of electrical current from the power input port to the indicator depending upon whether iron material is disposed within the zone.

In accordance with another embodiment, a method is provided for using a monitoring apparatus to monitor welding wire received by a welding machine from a wire source. The method comprises routing the welding wire from the wire source to the welding machine and at least partially within a zone defined by the monitoring apparatus. The method further comprises providing power to the monitoring apparatus and detecting with the monitoring apparatus whether the welding wire contains iron material. The method additionally comprises indicating by the monitoring apparatus whether the welding wire contains iron material.

In accordance with yet another embodiment, a monitoring apparatus is configured for association with a welding machine. The welding machine is configured to receive welding wire from a wire source. The monitoring apparatus comprises a housing and means supported by the housing for removably receiving a longitudinal portion of a welding wire passing from a wire source to a welding machine. The monitoring apparatus further comprises means supported by the housing for receiving power, as well as means supported by the housing for detecting whether the welding wire contains iron material. The monitoring apparatus additionally comprises means supported by the housing for indicating whether the welding wire contains iron material.

In accordance with still another embodiment, a monitoring apparatus is configured for association with a welding machine. The welding machine is configured to receive welding wire from a wire source. The monitoring apparatus consists essentially of a housing, a power input port, an indicator, a detector, and a control device. Each of the power input port, the indicator, the detector, and the control device is supported by the housing. The control device is configured to selectively facilitate passage of electrical current from the power input port to the indicator. At least one of the housing and the detector at least partially defines a zone configured to removably receive a longitudinal portion of a welding wire passing from a wire source to a welding machine. The detector is configured to facilitate passage of electrical current from the power input port to the indicator depending upon whether iron material is disposed within the zone.

### BRIEF DESCRIPTION OF THE DRAWINGS

While the specification concludes with claims particularly pointing out and distinctly claiming the present invention, it is believed that the same will be better understood from the following description taken in conjunction with the accompanying drawings in which:

FIG. 1 is a perspective view depicting a monitoring apparatus in accordance with one embodiment and in association with both a welding machine and a wire source;

FIG. 2 is a front perspective view depicting the monitoring apparatus of FIG. 1 in association with a welding wire;

FIG. 3A is a front elevational view depicting the monitoring apparatus of FIG. 1, wherein certain portions of the monitoring apparatus are removed for clarity of illustration;

FIG. 3B is a front elevational view depicting a portion of a monitoring apparatus in accordance with an alternative embodiment;

FIG. 3C is a front elevational view depicting a portion of a monitoring apparatus in accordance with another alternative embodiment;

FIG. 4A is a schematic diagram depicting the electrical circuit of the monitoring apparatus of FIG. 1;

FIG. 4B is a schematic diagram depicting an electrical circuit of a monitoring apparatus in accordance with an alternative embodiment;

FIG. 4C is a schematic diagram depicting an electrical circuit of a monitoring apparatus in accordance with another alternative embodiment;

FIG. 4D is a schematic diagram depicting an electrical circuit of a monitoring apparatus in accordance with yet another alternative embodiment; and

FIG. 4E is a schematic diagram depicting an electrical circuit of a monitoring apparatus in accordance with still another alternative embodiment.

### DETAILED DESCRIPTION

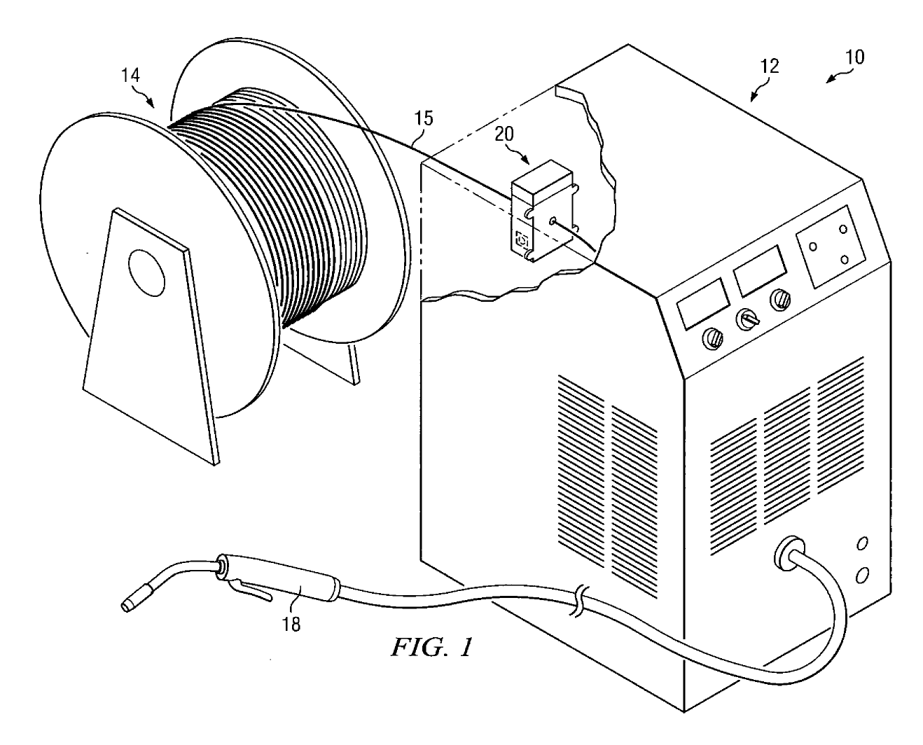

Certain embodiments are hereinafter described in detail in connection with the views and examples of FIGS. 1-2, 3A-3C, and 4A-4E, wherein like numbers illustrate like elements throughout the views. A monitoring apparatus can be provided to monitor welding wire for use in a welding process, and to indicate when the welding wire includes, or does not include, iron material. It will be appreciated that iron material can include iron, iron compounds, and alloys containing iron, such as those having a ferric and/or ferrous state.

Welding wire is available in a variety of different compositions. Some of those compositions include iron material, while others do not. Selection of welding wire for a particular welding project can depend upon factors such as the type of welding machine to be used, the types of materials to be welded, the desired performance of the finished weld, and/or environmental conditions during the welding process. During certain welding processes, it can be desirable to use welding wire which includes iron material. In those processes, the monitoring apparatus can be configured to alert an operator when welding wire is employed which does not contain iron material. During other welding processes, it can be desirable to use welding wire which does not include iron material. In those processes, the monitoring apparatus can be configured to alert an operator when welding wire is employed which contains iron material.

Conventional wire-fed welding machines are available in a variety of differing configurations, and are configurable to facilitate welding of various materials, and in a variety of different circumstances and environmental conditions. These conventional wire-fed welding machines are configured to receive welding wire from a wire source such as a spool or box. A monitoring apparatus as disclosed herein can be provided for use with any of a variety of these conventional wire-fed welding machines, of both manual and robotic types. One example of a conventional wire-fed welding machine is a metal inert gas (MIG) welder.

FIG. 1 illustrates a welding system 10 which includes a welding machine 12, such as a MIG welder. The welding machine 12 is shown to receive welding wire 15 from a wire source 14 which, in the example of FIG. 1, is shown to comprise a spool. In other embodiments, the wire source can comprise something other than a spool such as, for example, a box. Upon receipt of the welding wire 15 from the wire source 14, the welding machine 12 can selectively dispense the welding wire 15 through a welding gun 18 of the welding machine 12. Though not shown in FIG. 1, in addition to the welding wire 15, the welding machine 12 can also receive electrical power and a source of compressed gas (e.g., argon and/or carbon dioxide) for selective dispensation through the welding gun 18 along with the welding wire 15 to facilitate a welding process.

The welding system 10 of FIG. 1 is additionally shown to comprise a monitoring apparatus 20 which monitors the welding wire 15 passing from the wire source 14 to the welding machine 12. In the example of FIG. 1, the monitoring apparatus 20 is shown to be mounted to the welding machine 12. However, in alternative embodiments, a monitoring apparatus can be mounted to a wire source or can be supported at a position intermediate a wire source and a welding machine.

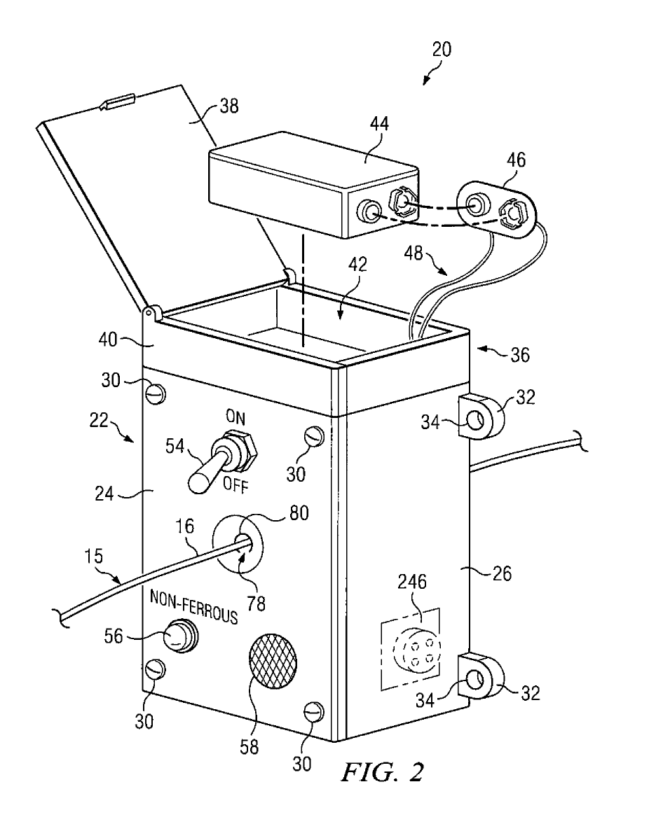

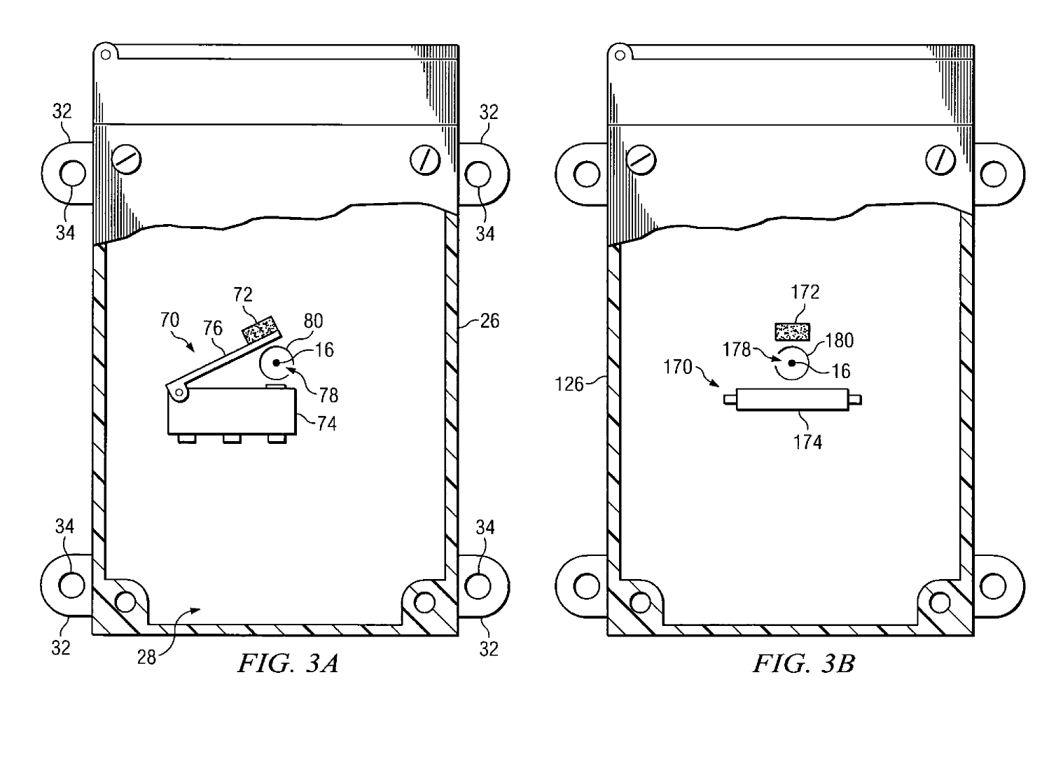

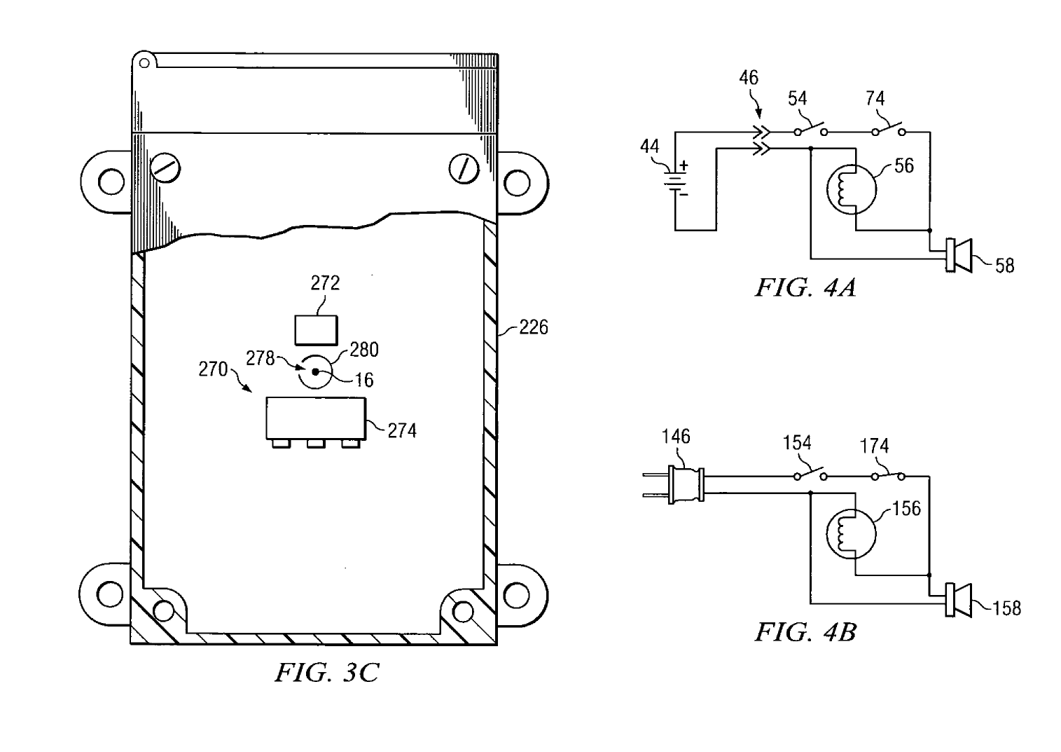

The monitoring apparatus 20 will now be described with further reference to FIGS. 2 and 3A. The monitoring apparatus 20 can include a housing 22 having a lid 24 and a base 26, as shown in FIG. 2. The lid 24 can be removably secured to the base 26 such as through use of screws 30. When the lid 24 is secured to the base 26, the lid 24 and the base 26 can cooperate to define a cavity 28 as generally shown in FIG. 3A. The cavity 28 can be configured to receive certain components of the monitoring apparatus 20 such as, for example, a detector 70. The housing 22 of the monitoring apparatus 20 can also include features which can facilitate mounting of the monitoring apparatus 20. For example, the housing 22 of FIGS. 2 and 3A is shown to include tabs 32 which each defines a respective aperture 34 for receiving a respective screw or other fastener to facilitate securement of the monitoring apparatus 20 such as to a welding machine, wire source, or other structure. It will be appreciated that a housing of a monitoring apparatus can have any of a variety of suitable sizes, shapes, and configurations alternative to that of the housing 22 of FIG. 2.

In the embodiment of FIGS. 2 and 3A, the housing 22 is shown to define a bore 80 which extends through the lid 24 and the base 26 of the housing 22, and which defines a zone 78 configured to removably receive a longitudinal portion 16 of the welding wire 15 as it passes from the wire source 14 to the welding machine 12. More particularly, the bore 80 can coaxially receive the longitudinal portion 16 of the welding wire 15 as it passes from the wire source 14 to the welding machine 12. As the longitudinal portion 16 of the welding wire 15 passes through the zone 78 defined by the bore 80, it can be seen in FIG. 3A that the longitudinal portion 16 of the welding wire 15 passes adjacent to the detector 70.

A zone can include space in which a detector of a monitoring apparatus can reliably and consistently detect the presence of iron material. For example, as shown in FIG. 3A, the zone 78 can be defined by the bore 80 in the housing 22 of the monitoring apparatus 20, such that the zone 78 is circumferentially defined and surrounded by portions of the housing 20. In an alternative embodiment, a monitoring apparatus can include a detector which defines a bore, such that the bore of the detector defines the zone, and such that a housing of the monitoring apparatus does not contribute in defining the zone. In another alternative embodiment, a housing and a detector of a monitoring apparatus can cooperate to define a zone. In still another alternative embodiment, a zone might not be circumferentially defined or surrounded by portions of a housing and/or detector. For example, a zone can be open on one or more sides to the environment, such that the welding wire need not be disconnected from the welding machine to be routed through the monitoring apparatus. In this latter configuration, it will be appreciated that, in lieu of a bore, a monitoring apparatus can include a notch or wall surface which at least partially defines a zone for receiving a longitudinal portion of a welding wire. Regardless of the location, shape, and size of the zone, it will be appreciated that a monitoring apparatus can be configured such that, during movement of welding wire through the zone during operation of an associated welding machine, the welding wire does not normally contact the monitoring apparatus, and thereby does not result in wear or other fatigue to the monitoring apparatus.

The detector 70 is shown in FIG. 3A to comprise a magnet 72, a reed switch 74, and an arm 76. The magnet 72 is shown to be attached to the arm 76, and the arm 76 is shown to be attached to the reed switch 74. The arm 76 can be configured to maintain a desired position of the magnet 72 with respect to the reed switch 74. The reed switch 74 and/or other portions of the detector 70 can be attached to, or otherwise supported by, the housing 26, as generally shown in FIG. 3A. The detector 70 can be positioned such that the bore 80 is located between the magnet 72 and the reed switch 74.

In one embodiment, the reed switch 74 can comprise a normally open, single-pole, single-throw, type switch. In this configuration, when the bore 80 is devoid of iron material, a magnetic field produced by the magnet 72 is received by the reed switch 74, and the reed switch 74 resultantly changes from a normally opened state to a closed state, thus allowing electrical current to flow through the reed switch 74. However, when iron material is placed within the zone 78 and between the magnet 72 and the reed switch 74, the magnetic field produced by the magnet 72 is not received by the reed switch 74, and the reed switch 74 resultantly assumes or remains in its normally opened state, thus preventing electrical current from flowing through the reed switch 74. In this configuration, when the welding wire 15 includes iron material, the longitudinal portion 16 of the welding wire 15 acts as a vane which interrupts passage of the magnetic field from the magnet 72 to the reed switch 74.

In another embodiment, the reed switch comprises a normally closed, single-pole, single-throw, type switch. In this configuration, when the bore is devoid of iron material, a magnetic field produced by the magnet is received by the reed switch, and the reed switch resultantly changes from a normally closed state to an opened state, thus preventing electrical current from flowing through the reed switch. However, when iron material is placed within the zone and between the magnet and the reed switch, the magnetic field produced by the magnet is not received by the reed switch, and the reed switch resultantly assumes or remains in its normally closed state, thus allowing electrical current to flow through the reed switch.

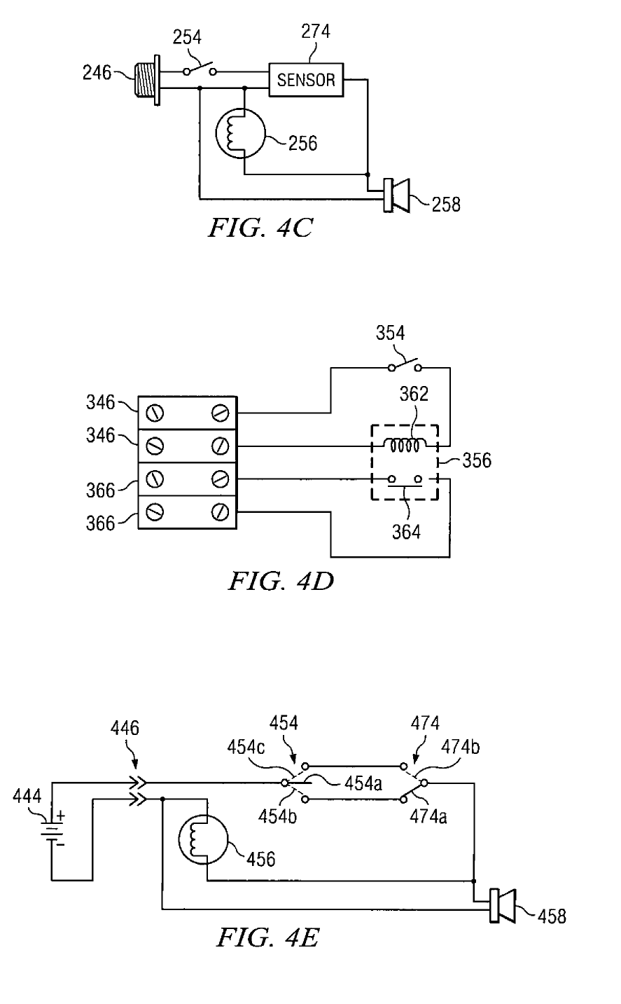

In yet another alternative embodiment, the reed switch can comprise a single pole, double-throw, type switch, and/or some other arrangement which includes both normally open and normally closed switch contacts (see, e.g., 474 in FIG. 4E). It will also be appreciated that a detector can include a magnet and a reed switch in any of a variety of alternative configurations. For example, in the embodiment of FIG. 3B, a detector 170 is shown to include a magnet 172 and a reed switch 174 which are each respectively and independently attached to a base 126 of a housing on opposite sides of a bore 180. The longitudinal portion 16 of the welding wire 15 passes through a zone 178 defined by the bore 180 and, depending upon whether the longitudinal portion 16 contains iron material, can serve as a vane to interrupt a magnetic field from the magnet 172 such that it does not reach the reed switch 174.

In another alternative embodiment, a detector might not comprise a reed switch. For example, in the embodiment of FIG. 3C, a detector 270 can comprise a sensor 274 which is attached to a base 226 of a housing and which comprises a Hall Effect sensor, a proximity sensor, and/or some other solid state or other sensor arrangement. When the sensor 274 comprises a Hall Effect sensor, the detector 270 can also include a magnet 272 which is attached to the base 226 on an opposite side of a bore 280 relative to the sensor 274. The longitudinal portion 16 of the welding wire 15 passes through a zone 278 defined by the bore 280 and, depending upon whether the longitudinal portion 16 contains iron material, can serve as a vane to interrupt a magnetic field from the magnet 272 such that it does not reach the sensor 274. However, when the sensor 274 comprises a proximity sensor, it will be appreciated that the magnet 272 might not be provided, as the sensor 274 can be configured to detect the presence of iron material within the bore 278 through any of a variety of known iron proximity detection arrangements other than involving vane interruption. It will be appreciated that a monitoring apparatus, in addition to being configured to detect the presence of iron material within the zone, can also be configured to detect the presence of other types of material within the zone, and/or can be configured to detect the presence or absence of welding wire within the zone.

Regardless of the specific configuration of the detector, the detector can be provided in electrical communication with each of a power input port and an indicator, as described in further detail below. As also described in further detail below, the detector can be configured to facilitate passage of electrical current from the power input port to the indicator depending upon whether iron material is disposed within the zone. For example, in one embodiment, the detector can be configured to facilitate passage of electrical current from the power input port to the indicator only when iron material is disposed within the zone. In such a configuration, for example, a power switch, such as toggle switch 54, need not be included. In another embodiment, the detector can be configured to facilitate passage of electrical current from the power input port to the indicator only when iron material is not disposed within the zone.

The power input port of a monitoring apparatus can be provided in any of a variety of suitable configurations. For example, as shown in FIG. 2, the power input port can comprise a battery connector 46 which is supported by the housing 26 through its connection by wires 48 with the remainder of the monitoring apparatus 20. The battery connector 46 can be configured for removable coupling to a battery 44. A battery housing 36 can be coupled with the housing 22 and can be configured for supporting the battery 44. The battery housing 36 is shown in FIG. 2 to include a door 38 and a base 40, and to define a cavity 42 for receiving the battery 44. It will be appreciated that a battery connector and battery housing can alternatively be configured to receive one or more batteries of a type different than that depicted in FIG. 2, and/or can be provided in any of a variety of other suitable configurations. In lieu of a battery connector, it will be appreciated that a power input port of a monitoring apparatus can comprise a device which is configured for receiving power from a remote power source, and thus can comprise, for example, a power cord (e.g., 146 in FIG. 4B), a connector (e.g., 246 in FIGS. 2 and 4C), or power terminals (e.g., 346 in FIG. 4D) such as may be provided upon a terminal block. The power input port can be configured for coupling to an alternating current power source or a direct current power source, and can be configured to receive voltage and current in any of a variety of suitable magnitudes.

The indicator of a monitoring apparatus can comprise any or a variety of suitable electrical and/or electromechanical devices which is/are supported by the housing of the monitoring apparatus and is/are configured to provide or facilitate provision of an audible indication, a visual indication, both audible and visual indications, or other types and combinations of indications to an operator. In one embodiment, the indicator includes at least one of an audible indicator and a visual indicator. Examples of an audible indicator can include, for example, a buzzer, a beeper, a speaker, a piezoelectric component, a bell, a horn, a solenoid, a motor, and/or any of a variety of other suitable components which are configured to produce a sound discernable by an operator. Examples of a visual indicator can include, for example, an indicator light, a display, a motor, a solenoid, and/or any of a variety of other suitable components which is/are configured to produce a visual effect discernable by an operator. Examples of suitable indicator lights can include one or more incandescent light sources, fluorescent light sources, high intensity discharge light sources, light emitting diodes (LEDs), and/or other suitable light sources. For example, as shown in FIG. 2, the monitoring apparatus 20 includes two indicators, namely an indicator light 56 and a buzzer 58. As another example, an indicator may include a multi-color LED with different colors corresponding to indications of ferrous or non-ferrous materials. In another embodiment, an indicator of a monitoring apparatus can include a relay or a hydraulic or pneumatic solenoid which is configured for coupling with one or more features that are remote from the monitoring apparatus, such as for providing an indication to an operator remotely from the monitoring apparatus, and/or for providing an enabling or disabling signal to a welding machine, control system, monitoring network, or other device. In this latter configuration, it will be appreciated that the monitoring apparatus can be conveniently integrated into the control system of a welding system, such as to facilitate its automatic enabling or disabling of a welding machine or other feature depending upon the type of wire detected by the monitoring apparatus.

The monitoring apparatus can further comprise a control device which is supported by the housing and is configured to selectively facilitate passage of electrical current from the power input port to the indicator. In one embodiment, a control device can be configured to facilitate selection by an operator from among a plurality of operating modes of a monitoring apparatus. Such operating modes can include, for example, a first mode in which the monitoring apparatus is OFF and unable to provide indication, and at least one second mode in which the monitoring apparatus is ON and able to provide indication. In one embodiment, such as described below with reference to FIG. 4E, such operating modes can include an OFF mode and two respective ON modes. When in the first ON mode, the monitoring apparatus can be configured to provide indication when welding wire contains iron material. When in the second ON mode, the monitoring apparatus can be configured to provide indication when welding wire does not contain iron material. In an alternative embodiment, a control device can be configured to facilitate selection by an operator of the type, manner, and duration of indication provided by a monitoring apparatus.

The control device can comprise a toggle switch, rocker switch, slide switch, plunger switch, pushbutton, or other type of switch which can facilitate selection by an operator from among multiple operating modes. For example, a control device is shown in FIG. 2 to comprise a toggle switch 54 which is moveable by an operator between a first or ON position, and a second or OFF position. As another example, a control device is shown in FIG. 4E to comprise a switch 454 which is moveable by an operator among three positions, particularly an OFF position (i.e., 454a) and two respective ON positions (i.e., 454b and 454c).

The electrical components of a monitoring apparatus can be selected and connected in any of a variety of suitable configurations, a few examples of which are shown in the schematic diagrams of FIGS. 4A-4E. FIG. 4A illustrates an arrangement in which the reed switch 74 comprises a normally open switch, such that the indicator light 56 and the buzzer 58 receive power from the battery 44 and the battery connector 46 only when both the toggle switch 54 is in an ON position and iron material is not within the zone 78. FIG. 4B illustrates an arrangement in which the reed switch 174 comprises a normally closed switch, such that an indicator light 156 and a buzzer 158 receive power from the power cord 146 only when both a switch 154 is in an ON position and iron material is within the zone 178 (see FIG. 3B). FIG. 4C illustrates an arrangement in which the sensor 274 is configured to receive power from the connector 246 when a switch 254 is in an ON position. The connector 246 can be connected to an external power supply. The sensor 274 can be configured to provide power from the connector 246 to an indicator light 256 and a buzzer 258 when welding wire within the zone 278 (see FIG. 3C) either contains, or does not contain, iron material. As previously indicated, the sensor 274 can comprise a Hall Effect sensor, a proximity sensor, and/or some other solid state or other sensor arrangement.

FIG. 4D illustrates an arrangement which does not include a control device, and which includes an indicator in the form of a relay 356. The power terminals 346 of a terminal block can be connected to an external power supply. A coil 362 of the relay 356 can be configured to receive power from the power terminals 346 so long as a detector 354 indicates that iron material is not within a zone. The relay 356 can also include one or more sets of contacts such as, for example, is shown at 364. The contacts (e.g., 364) can be connected with interface terminals 366 of the terminal block, as shown in FIG. 4D. The interface terminals 366 can be wired to one or more remote field devices, such as for provision of indication to an operator stationed remotely from the monitoring apparatus (e.g., SCADA monitoring), and/or for providing an enabling or disabling signal to a welding machine, control system, monitoring network, or other device. In this configuration, it will be appreciated that the monitoring apparatus can be conveniently integrated into the control system of a welding system, such as to facilitate its automatic enabling or disabling of a welding machine or other feature depending upon the type of wire detected by the monitoring apparatus. In addition or alternative to the relay 356, it will be appreciated that an indicator can comprise a solenoid valve which can selectively facilitate fluid flow for purposes of activating a remote signaling or control device.

FIG. 4E illustrates an arrangement in which a control device comprises a switch 454 which is movable among a first position 454a, a second position 454b, and a third position 454c. A battery 444 is shown to be coupled with a power input port 446. A detector is shown to comprise a single pole, double-throw, type reed switch 474 having a first position 474a and a second position 474b. The reed switch 474 can remain in the first position 474a so long as welding wire within an associated zone includes iron material. However, the reed switch 474 can move to the second position 474b when welding wire within the zone does not include iron material. When the switch 454 is in the first position 454a, electrical current is prevented from passing from the power input port 446 to an indicator light 456 and a buzzer 458. When the switch 454 is in the second position 454b, the reed switch 474 is configured to facilitate passage of electrical current from the power input port 446 to the indicator light 456 and the buzzer 458 when iron material is within the zone. When the switch 454 is in the third position 454c, the reed switch 474 is configured to facilitate passage of electrical current from the power input port 446 to the indicator light 456 and the buzzer 458 when iron material is not within the zone.

In order to use the monitoring apparatus 20, the housing 22 of the monitoring apparatus 20 can be secured to the welding machine 12, as shown in FIG. 1, for example. Welding wire 15 from the wire source 14 can be routed through the zone 78 defined by the bore 80 of the monitoring apparatus 20, and then into the welding machine 12. The battery 44 can then be connected to the battery connector 46 and placed within the battery housing 36. The switch 54 can then be moved to the ON position, such that the indicator light 56 and the buzzer 58 can respectively visually and audibly indicate whether the welding wire contains iron material. For example, in the embodiment of FIG. 4A, in which the reed switch 74 is of a normally open type, the indicator light 56 and the buzzer 58 can receive power through the reed switch 74 when the zone 78 is devoid of iron material. In an alternative example, in which a reed switch is of a normally closed type (see 174 in FIG. 4B), an associated indicator light and buzzer can receive power through the reed switch when iron material is placed within the zone.

A monitoring apparatus can be a self-contained unit which can be field-installed as an aftermarket accessory for use with an existing welding system. Through installation and use of a monitoring apparatus as described herein, it will be appreciated that a welding system can be easily, quickly, and inexpensively retrofitted to facilitate detection and indication of whether welding wire contains iron material. Such indication can alert an operator of a welding machine, and can accordingly render it less likely that an operator will inadvertently feed improper welding wire to a welding machine.

The foregoing description of embodiments and examples of the invention has been presented for purposes of illustration and description. It is not intended to be exhaustive or to limit the invention to the forms described. Numerous modifications are possible in light of the above teachings. Some of those modifications have been discussed and others will be understood by those skilled in the art. The embodiments were chosen and described in order to best illustrate the principles of the invention and various embodiments as are suited to the particular use contemplated. The scope of the invention is, of course, not limited to the examples or embodiments set forth herein, but can be employed in any number of applications and equivalent devices by those of ordinary skill in the art. Rather it is hereby intended the scope of the invention be defined by the claims appended hereto.

What is claimed is:

1. A monitoring apparatus configured for association with a welding machine, the welding machine configured to receive welding wire from a wire source, the monitoring apparatus comprising:
a housing;
a power input port supported by the housing;
an indicator supported by the housing; and
a detector supported by the housing and in electrical communication with each of the power input port and the indicator, wherein:
at least one of the housing and the detector at least partially defines a zone configured to removably receive a longitudinal portion of a welding wire passing from a wire source to a welding machine;
the detector is configured to facilitate passage of electrical current from the power input port to the indicator depending upon whether iron material is disposed within the zone.

2. The monitoring apparatus of claim 1 wherein the indicator comprises at least one of an audible indicator and a visual indicator.

3. The monitoring apparatus of claim 2 wherein the visual indicator comprises an indicator light.

4. The monitoring apparatus of claim 1 wherein the detector comprises a magnet and a reed switch.

5. The monitoring apparatus of claim 1 wherein the detector comprises a magnet and a Hall Effect sensor.

6. The monitoring apparatus of claim 1 wherein the detector comprises a proximity sensor.

7. The monitoring apparatus of claim 1 wherein the housing is configured for securement to at least one of a welding machine and a wire source.

8. The monitoring apparatus of claim 1 wherein at least one of the housing and the detector defines a bore, the bore defines the zone, and the bore is configured to coaxially receive a longitudinal portion of a welding wire passing from a wire source to a welding machine.

9. The monitoring apparatus of claim 1 further comprising a control device configured to selectively facilitate passage of electrical current from the power input port to the indicator.

10. The monitoring apparatus of claim 9 wherein the control device comprises a switch movable among a first position, a second position, and a third position, wherein:
in the first position, electrical current is prevented from passing from the power input port to the indicator;
in the second position, the detector is configured to facilitate passage of electrical current from the power input port to the indicator when iron material is within the zone; and
in the third position, the detector is configured to facilitate passage of electrical current from the power input port to the indicator when iron material is not within the zone.

11. The monitoring apparatus of claim 9 wherein the control device comprises a switch movable between a first position and a second position, wherein:
in the first position, electrical current is prevented from passing from the power input port to the indicator; and
in the second position, the detector is configured to facilitate passage of electrical current from the power input port to the indicator when iron material is within the zone.

12. The monitoring apparatus of claim 9 wherein the control device comprises a switch movable between a first position and a second position, wherein:
in the first position, electrical current is prevented from passing from the power input port to the indicator; and
in the second position, the detector is configured to facilitate passage of electrical current from the power input port to the indicator when iron material is not within the zone.

13. A method of using a monitoring apparatus to monitor welding wire received by a welding machine from a wire source, the method comprising:
routing the welding wire from the wire source to the welding machine and at least partially within a zone defined by the monitoring apparatus;
providing power to the monitoring apparatus;
detecting with the monitoring apparatus whether the welding wire contains iron material; and
indicating by the monitoring apparatus whether the welding wire contains iron material.

14. The method of claim 13 wherein the providing power to the monitoring apparatus comprises connecting a battery to the monitoring apparatus.

15. The method of claim 13 wherein the indicating comprises at least one of providing an audible indication and a visual indication.

16. The method of claim 13 wherein the routing comprises passing the welding wire through a bore defined by the monitoring apparatus, and wherein the bore defines the zone.

17. The method of claim 13 further comprising selectively operating a control device of the monitoring apparatus to enable at least one of the detecting and the indicating.

18. The method of claim 13 further comprising mounting the monitoring apparatus.

19. The method of claim 18 wherein the mounting of the monitoring apparatus comprises securing a housing of the monitoring apparatus to one of a welding machine and a wire source.

20. A monitoring apparatus configured for association with a welding machine, the welding machine configured to receive welding wire from a wire source, the monitoring apparatus comprising:
a housing;
means supported by the housing for removably receiving a longitudinal portion of a welding wire passing from a wire source to a welding machine;
means supported by the housing for receiving power;
means supported by the housing for detecting whether the welding wire contains iron material; and
means supported by the housing for indicating whether the welding wire contains iron material.

21. A monitoring apparatus configured for association with a welding machine, the welding machine configured to receive welding wire from a wire source, the monitoring apparatus consisting essentially of:
a housing;
a power input port supported by the housing;
an indicator supported by the housing;
a detector supported by the housing; and
a control device supported by the housing and configured to selectively facilitate passage of electrical current from the power input port to the indicator, wherein:
at least one of the housing and the detector at least partially defines a zone configured to removably receive a longitudinal portion of a welding wire passing from a wire source to a welding machine; and
the detector is configured to facilitate passage of electrical current from the power input port to the indicator depending upon whether iron material is disposed within the zone.

22. The monitoring apparatus of claim 21 wherein the power input port is configured for removable coupling to a battery.
